(19) United States
(12) Patent Application Publication
(10) Pub. No.: US 2003/0098855 A1
(43) Pub. Date: May 29, 2003

(54) Portable communication device with reading function

(76) Inventor: Yi Wen Lin, Taipei City (TW)

Correspondence Address: Yi Wen Lin, PO Box 82-144, TAIPEI, TW

(21) Appl. No.: 09/991,674

(22) Filed: Nov. 26, 2001

(51) Int. Cl. G09G 5/00

(52) U.S. Cl. 345/173

(57) ABSTRACT

A portable communication device with reading function is disclosed. The device allows a name card to be inserted into a name card insertion slot and the data on the name card is rapidly read, and a microprocessor (CPU) classifies the read data and store into a specific name card data file memory so as to conveniently provide the user the relevant data of a clients, friends and relatives.

### BACKGROUND OF THE INVENTION

(a) Technical Field of the Invention

The present invention relates to a portable communication device with reading function, and in particular, a communication device which can rapidly read the stored data on a chip of a name card, and a microprocessor (CPU) classifies the read data and store into a specific name card data file memory so as to conveniently provide the user the relevant data of a clients, friends and relatives.

(b) Description of the Prior Art

Mobile phone is a portable communication device having data input function by either inputting words or letters by means of buttons, or by touch screen method. However, these two methods are complicated and time-consuming, which are not fit in view of economical benefit.

In social function, name cards are exchanged in order to know each other, but the data or the name cards are frequently changed as a result of leaving to a new career or relocation to a new address. In view of the above, the name cards have to be reprinted for future application. The conventional name cards have the following drawbacks.

Paper materials are used in printing name cards.

It is inconvenient to carry too many name cards.

It is time-consuming to sort name cards.

The surface area of a name card is limited, detailed description of products is not possible.

New name card has to be printed if any of the name card data is changed, and therefore, it is wastage of paper and printing ink.

Accordingly it is an object of the present invention to provide a portable communication device with reading function, which mitigates the above drawbacks.

### SUMMARY OF THE INVENTION

Accordingly, it is an object of the present invention to provide a portable communication device with reading function, wherein the device comprises a read device for rapid reading of data stored in name cards and display on a screen; an input device to categorize data items; and a microprocessor to classify the read data and store in a specific name card data file memory; thereby name card data of clients, friends and relatives are stored and can be easily and rapidly utilized.

Yet a further object of the present invention is to provide a portable communication device with reading function, wherein the device allows instantaneous reading by the other party.

A further object of the present invention is to provide a portable communication device with reading function, wherein a chip is mounted onto a name card and therefore, printing of name card is not needed.

Still a further object of the present invention is to provide a portable communication device with reading function, wherein the data on the name card can be rapidly read.

Still another object of the present invention is to provide a portable communication device with reading function, wherein any data change to the name card can be made to the device by input the new data into the device.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flowchart showing the application of the present invention.

FIG. 2 is a circuit block diagram in accordance with the present invention.

FIG. 3 is a perspective view of the device of the present invention.

FIGS. 4A, 4B and 4C show the various storage forms of name card in accordance with the present invention.

FIG. 5 is a perspective view showing the application of the present device together with a PDA.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

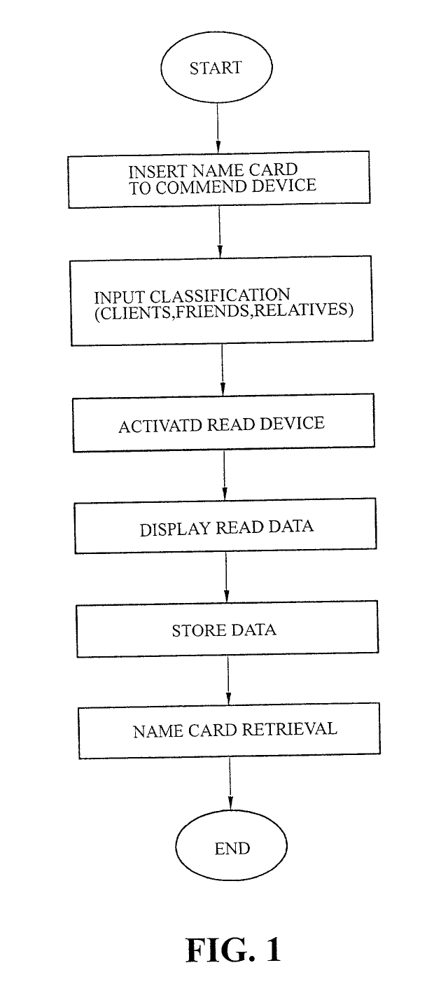

Referring to FIG. 1, there is shown the flowchart of the application of the present invention.

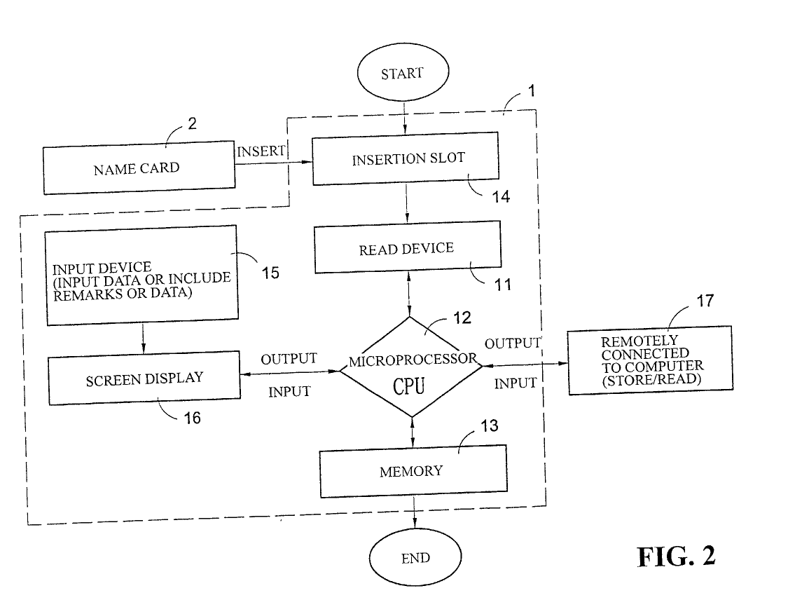

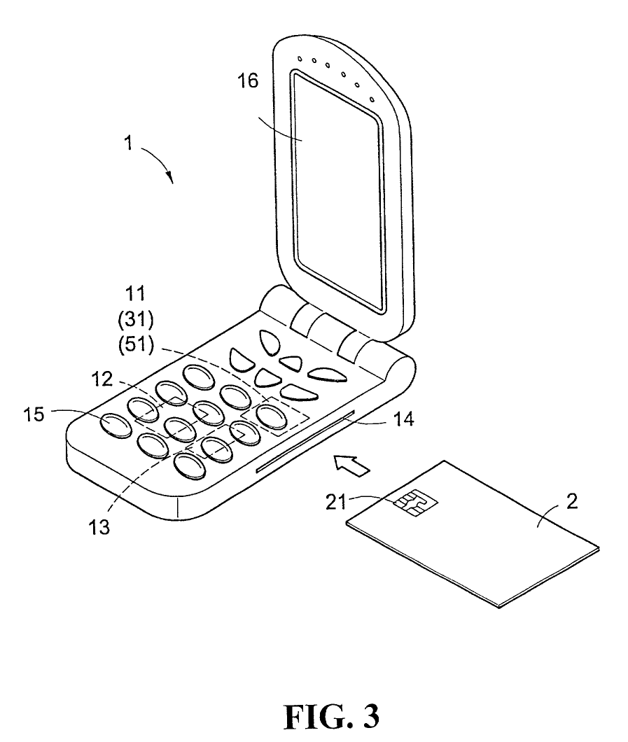

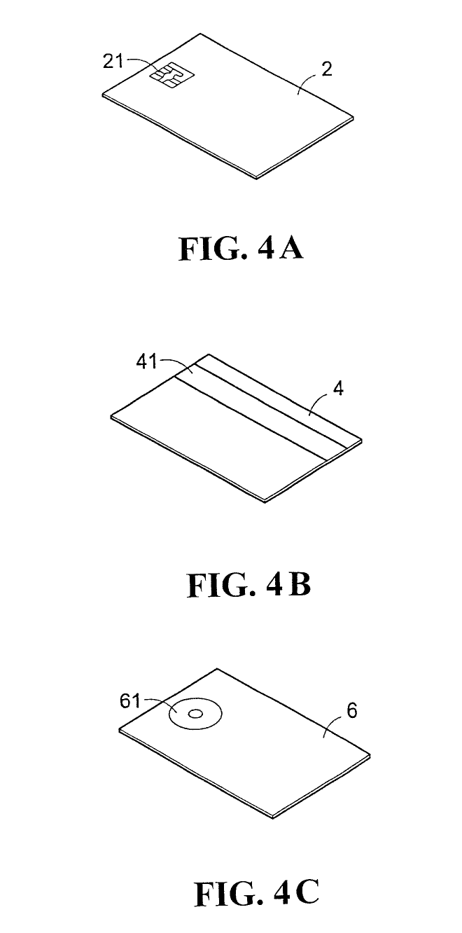

As shown in FIGS. 2 and 3, the communication device (for instance, mobile phone 1) is provided with an insertion slot 14 having mounted internally a chip read device 11. A name card 2 containing relevant data on a chip 21 can be inserted into the insertion slot 14, and the read device 11 can rapidly access the stored data in the chip 21 and the data is displayed on a screen display 16. At the same time, by means of the input device of the mobile phone 1 (for instance, touch button 15 or touch control screen) the classified items are selected. By means of the microprocessor 12 of the mobile phone, the data are classified and stored in the memory 13 of a specific name card data file facilitating rapid and convenient access of the relevant data of clients, friends and relatives. The present communication device can be connected externally to a computer 17 for the transferring and storage of data. Referring to FIG. 4A, a chip 21 is mounted onto a chip 2 for data storage, or other form of data storage can be used. For instance, as shown in FIG. 4B, a magnetic bar 41 is used on the name card 4, or as shown in FIG. 4C, a mini-disc 61 is used on a name card 6. In accordance with the present invention, a magnetic bar read device 31 or an optical disk read device 51 is mounted correspondingly to read the name cards 4, 6 with different forms of data storage.

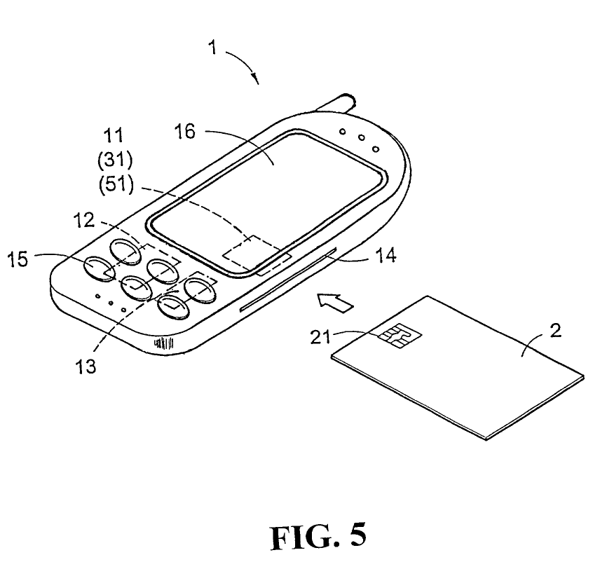

FIG. 5 is another preferred embodiment showing the application of the present device together with a PDA.

In view of the above, the present communication device facilitates rapid access of data contained (stored) in a name card.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A portable communication device with reading function for name card data comprising:
a read device for rapid reading of data stored in name cards and display on a screen;
an input device to categorize data items; and
a microprocessor to classify the read data and store in a specific name card data file memory;
whereby name card data of clients, friends and relatives are stored and can be easily and rapidly utilized.

2. The portable communication device with reading function for name card data as claimed in claim 1, further comprising:
a name card containing relevant data of a limited company or a company;
a read device for the insertion of the name card;
a screen display to display the stored data of the name card;
an input device to deliver categorized items and to amend or insert remarks;
a microprocessor to classify the read data; and
a memory for the storage of the relevant data of the name card.

3. The portable communication device of claim 1, wherein the storage mode of the name card is a magnetic bar, optical disc stored format for the reading of a read device by incorporating a corresponding magnetic bar read device or optical disk read device at a relevant read position to allow rapid reading of name card data.

4. The portable communication device of claim 1, wherein a remote computer is connected to the device for data transferring and storage.
